(19) United States
(12) Patent Application Publication
(10) Pub. No.: US 2025/0296485 A1
(43) Pub. Date: Sep. 25, 2025

(54) SEAT CUSHION AIR BAG DEVICE AND SEAT CUSHION AIR BAG STRUCTURE

(71) Applicant: TOYODA GOSEI CO., LTD., Kiyosu-shi (JP)

(72) Inventors: Masashi HOTTA, Aichi (JP); Yuji MATSUZAKI, Aichi (JP); Motoyuki TANAKA, Aichi (JP)

(21) Appl. No.: 19/085,642

(22) Filed: Mar. 20, 2025

(30) Foreign Application Priority Data
Mar. 25, 2024 (JP) 2024-048820

(51) Int. Cl. B60N 2/427; B60N 2/433

(52) U.S. Cl. CPC B60N 2/42763; B60N 2/433

(57) ABSTRACT

A seat cushion air bag structure includes: a seat support portion disposed below a seat surface of a seat of a vehicle; a seat cushion air bag disposed below the seat surface and above the seat support portion and configured to be deployed and inflated when an impact occurs to the vehicle; and a tether portion containing fabric, and the tether portion is bridged over the seat support portion in at least one of: at least a partial region of the tether portion in a front-rear direction of the seat; or at least a partial region of the tether portion in a width direction of the seat, at a position below the seat cushion air bag.

### CROSS REFERENCE TO RELATED APPLICATION

This application is based on and claims priority under 35 USC 119 from Japanese Patent Application No. 2024-048820 filed on Mar. 25, 2024.

### TECHNICAL FIELD

The present invention relates to a seat cushion air bag device and a seat cushion air bag structure to be mounted on a seat of a vehicle.

### BACKGROUND ART

It is known that when an impact occurs in a vehicle, such as during a collision, a phenomenon occurs in which an occupant seated on a seat of the vehicle moves forward or downward despite wearing a seat belt.

The terms “front” and “forward” and the like in the present specification refer to the front and forward and the like in a front-rear direction relative to the body of the occupant seated on a seat portion of the seat. Similarly, the terms “rear” and “rearward” and the like refer to the rear and rearward and the like in the front-rear direction relative to the body of the occupant seated on the seat portion of the seat. In the present specification, a width direction described later refers to a direction that is horizontal and orthogonal to the front-rear direction. Further, the terms “upper” and “lower” mean up in a vertical direction and down in a vertical direction, respectively.

As one type of the above phenomenon, for example, a phenomenon (so-called submarine phenomenon) in which an occupant slides down from a seat surface of a seat to a lower front side is known.

It is considered that the submarine phenomenon is caused by the fact that, when an impact is applied to the vehicle from the front, the waist of the occupant moves forward and passes under a waist strap (also referred to as a waist belt or a lap strap) of the seat belt which is used to restrain the waist of the occupant.

In order to prevent such a phenomenon in which the occupant moves, a technique has been proposed in which an air bag referred to as a seat cushion air bag is provided below a seat surface of a seat, more specifically, inside a seat portion (for example, see Patent Literature 1).

For example, in the technique described in Patent Literature 1, when an impact occurs, a seat cushion air bag is deployed and inflated to raise the seat surface of the seat. Paragraphs 0007, etc. of Patent Literature 1 describe that the seat cushion air bag lifts the thighs of the occupant to prevent the occupant from moving forward.

### PATENT LITERATURE

Patent Literature 1: JP2018-188123A
Patent Literature 2: JP2012-106617A

### SUMMARY OF INVENTION

As described above, the seat cushion air bag described in Patent Literature 1 is deployed and inflated when an impact occurs. At the time of deployment and inflation, the seat cushion air bag raises the waist of the occupant from below the waist. As a result, it is considered that the occupant is prevented from moving forward, thereby making the submarine phenomenon described above less likely to occur.

Here, an occupant is seated above the seat cushion air bag and the seat portion, and a downward load caused by the occupant acts on the seat portion. Therefore, immediately after the seat cushion air bag is deployed and inflated, the seat portion is difficult to deform upward due to the occupant.

That is, immediately after the seat cushion air bag is deployed and inflated, the seat portion first deforms downward, which is the more easily deformed direction, and then deforms upward. Therefore, when the seat cushion air bag is deployed and inflated, a large downward force acts on the seat portion of the seat.

In order to stably restrain and support the occupant by the seat belt when an impact occurs, it is preferable to largely raise the waist of the occupant sitting on the seat, and for this purpose, it is necessary to greatly deploy and inflate the seat cushion air bag in an upper-lower direction.

However, when the seat cushion air bag is deployed and inflated greatly in the upper-lower direction, a downward force acting from the seat cushion air bag on the seat portion of the seat also becomes large.

A typical seat includes a seat support portion such as a seat pan or a seat bar. The seat support portion is a member that is disposed below at least a part of a cushion portion of the seat and that supports the seat portion of the seat, including the cushion portion, and the occupant sitting on the seat portion from below.

Such a seat support portion is pressed downward by the seat cushion air bag that is deployed and inflated and deformed downward. Therefore, when a deployment and inflation force of the seat cushion air bag is set to be large in order to greatly raise the waist of the occupant sitting on the seat when an impact occurs, the seat support portion is greatly pressed downward by the seat cushion air bag when the impact occurs. At this time, there is a risk that the seat support portion may be deformed.

Patent Literature 2 proposes a technique in which a seat pan, which is a part of a seat support portion, is extended in the front-rear direction of a seat and the seat pan is bridged over a seat bar, which is another part of the seat support portion.

According to the technique described in Patent Literature 2, a large seat pan extending in the front-rear direction of the seat comes into contact with a seat cushion air bag at the time of deployment and inflation from below over a large area. Therefore, the seat pan receives an external force due to the deployment and inflation of the seat cushion air bag in a distributed manner, and generates a reaction force due to the external force in a distributed manner. As a result, with this seat pan, the seat cushion air bag can be supported from below while reducing deformation of the entire seat support portion, and there is a possibility that the seat cushion air bag can be deployed and inflated greatly in an upward direction.

When the seat pan is large and the seat pan extends in the front-rear direction of the seat as described in Patent Literature 2, the seat pan is provided below the buttocks of the occupant.

The seat pan is made of a material having high rigidity for supporting the seat portion of the seat from below. Therefore, in a case where a large seat pan extends in the front-rear direction of the seat and the seat pan is provided below the buttocks of the occupant, the cushioning property of the seat is impaired, and the sitting comfort of the seat is significantly deteriorated.

The present invention has been made in view of the above circumstances, and an object of the present invention is to provide a seat cushion air bag device capable of supporting a seat cushion air bag at the time of deployment and inflation by coming into contact with the same from below over a large area, and capable of maintaining good sitting comfort of a seat.

A seat cushion air bag device according to an aspect of the present invention is a seat cushion air bag device including:
a seat cushion air bag disposed below a seat surface of a seat of a vehicle and above a seat support portion of the seat and configured to be deployed and inflated when an impact occurs to the vehicle; and a tether portion made of fabric, in which the tether portion is bridged over the seat support portion in at least a partial region of the tether portion in a front-rear direction of the seat and/or in at least a partial region of the tether portion in a width direction of the seat at a position below the seat cushion air bag.

A seat cushion air bag structure according to an aspect of the present invention is a seat cushion air bag structure including:
a seat support portion disposed below a seat surface of a seat of a vehicle;
a seat cushion air bag disposed below the seat surface and above the seat support portion and configured to be deployed and inflated when an impact occurs to the vehicle; and
a tether portion made of fabric, in which
the tether portion is bridged over the seat support portion in at least a partial region of the tether portion in a front-rear direction of the seat and/or in at least a partial region of the tether portion in a width direction of the seat at a position below the seat cushion air bag.

According to the technique of the present invention, it is possible to provide a seat cushion air bag device capable of supporting a seat cushion air bag at the time of deployment and inflation by coming into contact with the same from below over a large area, and capable of maintaining good sitting comfort of a seat.

### BRIEF DESCRIPTION OF DRAWINGS

FIG. 1 is a diagram schematically illustrating a seat cushion air bag structure according to a first embodiment.

FIG. 2 is a diagram schematically illustrating the seat cushion air bag structure according to the first embodiment.

FIG. 3 is a diagram schematically illustrating the seat cushion air bag structure according to the first embodiment.

FIG. 4 is a diagram schematically illustrating a state in which an air bag in the seat cushion air bag structure according to the first embodiment is viewed from below.

FIG. 5 is a diagram schematically illustrating a seat cushion air bag structure of a second embodiment.

FIG. 6 is a diagram schematically illustrating a seat cushion air bag structure of the second embodiment.

### DESCRIPTION OF EMBODIMENTS

A seat cushion air bag device according to the present invention is disposed below a seat surface of a seat of a vehicle and above a seat support portion of the seat, and includes a seat cushion air bag and a tether portion.

In this regard, a seat cushion air bag structure according to the present invention includes the seat support portion as a component in addition to the seat cushion air bag device according to the present invention.

The seat support portion referred to in the present specification is a general term for a rigid body that is disposed below at least a part of a cushion portion of a seat portion, and refers to a portion that supports the entire seat portion including the cushion portion. The seat support portion includes a seat pan, a seat bar (also referred to as a shaft), a seat frame including a side frame, and the like.

The seat cushion air bag device according to the present invention includes the seat cushion air bag that is deployed and inflated when an impact occurs to the vehicle, and the tether portion made of fabric.

The tether portion is provided below the seat cushion air bag, and is bridged over the seat support portion in at least a partial region of tether portion in a front-rear direction of the seat and/or in at least a partial region of the tether portion in a width direction of the seat. Such a tether portion comes into contact with the seat cushion air bag over a large area at the time of deployment and inflation, and can efficiently receive an external force generated by the seat cushion air bag.

The tether portion is bridged over the seat support portion. Therefore, the tether portion generates a reaction force caused by the external force generated by the seat cushion air bag, and can stably support the seat cushion air bag from below.

Further, the tether portion is bridged over the seat support portion in at least a partial region of the tether portion in the front-rear direction of the seat and/or in at least a partial region of of the tether portion in the width direction of the seat. Therefore, the tether portion can receive the external force generated by the seat cushion air bag in a distributed manner, and can sufficiently distribute the reaction force caused by the seat cushion air bag during deployment and inflation. Therefore, the external force generated by the seat cushion air bag does not unevenly act on one part of the seat, making it possible to prevent a failure such as deformation of the seat support portion of the seat.

In addition, the tether portion is made of fabric, and therefore is bendable and deformable. Therefore, when an occupant sits on the seat and the seat portion of the seat, including the cushion and a surface, is deformed downward, the tether portion below the seat surface of the seat is bent and deformed downward.

Therefore, in the seat cushion air bag device according to the present invention, the cushioning property of the seat is unlikely to be impaired, and the sitting comfort of the seat can be maintained at a good level.

According to the seat cushion air bag device of the present invention, the cooperation of the above has the effect of sufficiently distributing the reaction force caused by the seat cushion air bag at the time of deployment and inflation, and maintaining the sitting comfort of the seat at a good level.

As described above, the seat cushion air bag structure according to the present invention includes the seat support portion as a component in addition to the seat cushion air bag device according to the present invention.

Therefore, according to the seat cushion air bag structure of the present invention, similarly to the seat cushion air bag device of the present invention, the reaction force caused by the seat cushion air bag at the time of deployment and inflation can be sufficiently distributed, and the sitting comfort of the seat can be maintained at a good level.

Hereinafter, the seat cushion air bag device and the seat cushion air bag structure according to the present invention will be described with respect to each of their components.

As described above, the seat cushion air bag structure according to the present invention includes the seat cushion air bag device according to the present invention. Therefore, unless otherwise specified, in the present specification, the description of each part of the seat cushion air bag device in the seat cushion air bag structure of the present invention can be read as the description of each part of the seat cushion air bag device of the present invention.

Hereinafter, unless otherwise specified, a front-rear direction, a width direction, and an upper-lower direction refer to respective directions in a seat, more specifically, respective directions based on an occupant seated in the seat. The width direction may also be referred to as a left-right direction from the perspective of the occupant.

Unless otherwise specified, a numerical value range “x to y” described in the present specification includes a lower limit value x and an upper limit value y. The upper limit value, the lower limit value, and numerical values listed in the embodiments may be freely combined to form a new numerical value range. Further, a numerical value freely selected from the above-described numerical value range can be set as an upper limit numerical value or a lower limit numerical value of a new numerical value range.

The seat cushion air bag structure according to the present invention is disposed below a seat surface of a seat of a vehicle and above a seat support portion of the seat.

As described above, the seat support portion is a portion of the seat that supports the seat portion. The seat includes the seat portion on which an occupant sits, the seat support portion that supports the seat portion from below, a backrest that is provided behind the seat portion and supports the back of the occupant, an armrest that is provided on a front side of the seat portion in the width direction, and the like.

The seat in the present specification may be any seat on which an occupant can sit, and may be, for example, a front seat such as a driver's seat or a passenger's seat, or a rear seat.

The seat portion includes the cushion portion and a surface portion exposed outside of the cushion portion. The seat surface of the seat is formed by the surface portion of the seat portion.

The seat cushion air bag is deployed and inflated when an impact occurs to the vehicle, thereby lifting the seat surface of the seat and thus raising the waist of the occupant sitting in the seat. Accordingly, the seat cushion air bag structure according to the present invention which includes the seat cushion air bag can prevent the submarine phenomenon described above. By using the seat cushion air bag to raise the waist of the occupant and thus raise the upper body of the occupant, there is also an advantage that the chest of the occupant can be stably supported by a shoulder strap of the seat belt, which is used to restrain the chest of the occupant.

The seat cushion air bag is configured to deploy and inflate when an impact occurs, and generally has a bag shape. The seat cushion air bag device may include an inflation fluid generation source that is connected to the seat cushion air bag for supplying inflation fluid to the seat cushion air bag. Hereinafter, unless otherwise specified, an air bag in this specification refers to an air bag in the seat cushion air bag device.

When the air bag is deployed and inflated, the air bag deforms and pushes the seat surface of the seat portion of the seat to the upward direction.

Such an air bag is preferably stored in the seat portion in a folded or crushed state in a normal state, and a foldable and deployable material is preferably selected as the material for the air bag.

As a specific material of the air bag, a bendable and high-strength material is preferably selected, and for example, a woven fabric using a high-strength resin fiber such as polyester and polyamide can be particularly preferably used.

The inflation fluid generation source preferably uses a so-called inflator that generates gas as the inflation fluid, and in some cases, the inflation fluid generation source may generate an inflation fluid other than gas, for example, liquid or gel.

The inflation fluid generation source may be a device for supplying inflation fluid to the air bag, and may be, for example, a so-called pyrotechnic inflator including a gas generating agent that generates gas as the inflation fluid. Alternatively, a so-called hybrid type inflator that breaks a partition wall of a high-pressure container to supply gas stored in the high-pressure container may be used. The inflation fluid generation source may be entirely disposed outside the air bag, or may be partially or entirely disposed inside the air bag.

The seat cushion air bag structure according to the present invention includes the tether portion made of fabric. The tether portion is bridged over the seat support portion in at least a partial region of tether portion in the front-rear direction of the seat and/or in at least a partial region of the tether portion in the width direction of the seat at a position below the air bag

The tether portion may be made of any material as long as it is made of fabric, that is, woven material, and the weaving method is not particularly limited. The material for the tether portion may be appropriately selected according to the strength required for the tether portion. Specific examples of the material for the tether portion include, but are not limited to, high-strength resin fibers, glass fibers, carbon fibers, metal fibers, and natural fibers derived from plants and the like, which are similar to those for the air bag.

The tether portion is required to be capable of sufficiently bending and deforming in the upper-lower direction and sufficiently supporting the air bag from below at the time of deployment and inflation. It is more preferable that such a tether portion has flexibility and is difficult to stretch and deform.

Since the tether portion in the seat cushion air bag structure according to the present invention is made of fabric, the tether portion is less susceptible to stretching and deformation than, for example, a tether portion made of knitted or nonwoven fabric. Therefore, it can be said that the tether portion in the seat cushion air bag structure according to the present invention can be sufficiently bent and deformed in the upper-lower direction and can sufficiently support the air bag from below at the time of deployment and inflation.

In other words, since the tether portion in the seat cushion air bag structure according to the present invention is made of fabric, the tether portion is brought into contact with the air bag at the time of deployment and inflation from below over a large area, and the air bag can be stably supported from below, while still providing the effect of maintaining good sitting comfort of the seat.

The tether portion is bridged over the seat support portion in at least a partial region of the tether portion in the front-rear direction of the seat and/or in at least a partial region of the tether portion in the width direction of the seat.

In the seat cushion air bag structure according to the present invention, the region of the seat over which the tether portion is bridged is not particularly limited, but is preferably, for example, 30% or more, 50% or more, or 70% or more of a length of the seat portion in the front-rear direction and/or width direction of the seat.

When the tether portion is bridged over the seat support portion in at least a partial region of the tether portion in the front-rear direction of the seat, a length of the tether portion in the width direction is preferably 30% or more, 50% or more, or 70% or more of the length of the seat portion in the width direction, or equal to or greater than a width of the air bag.

When the tether portion is bridged over the seat support portion in at least a partial region of the tether portion in the width direction of the seat, a length of the tether portion in the front-rear direction is preferably 30% or more, 50% or more, or 70% or more of the length of the seat portion in the front-rear direction, or equal to or greater than a length of the air bag in the front-rear direction.

When the tether portion is disposed above a seat spring in the seat portion, there is an advantage that the reaction force caused by the deployment and inflation of the air bag can be efficiently generated by the tether portion.

The seat spring is a member that forms a part of the seat portion and is disposed below the cushion. Since the seat spring is interposed between the cushion and the seat frame, thereby absorbing vibrations and the like that occur when the vehicle is traveling. This improves the ride comfort of the seat.

When a downward load acts on the seat spring, the seat spring is elastically compressed downward. Therefore, in a case where the seat spring is provided directly below the air bag, when the air bag is deployed and inflated downward at the time of occurrence of an impact and presses the seat spring downward, the seat spring is compressed to buffer an external force acting downward from the air bag. Therefore, depending on the spring characteristics of the seat spring, the reaction force acting on the air bag from below the air bag at the time of deployment and inflation is reduced, and the position of a lower end portion of the air bag is also lowered. As a result, it is difficult to quickly deploy and inflate the air bag upward, which may in turn make it difficult to quickly raise the seat surface of the seat.

When the tether portion is disposed above the seat spring in the seat portion, the tether portion is interposed between the air bag and the seat spring. As described above, the tether portion is bridged over the seat support portion, and generates the reaction force when receiving the external force generated when the air bag is deployed and inflated. Therefore, in this case, the external force generated by the air bag at the time of deployment and inflation is not easily transmitted to the seat spring. Therefore, in this case, the air bag can be quickly deployed and inflated upward, and thus the seat surface of the seat can be quickly raised.

The tether portion is bridged over the seat support portion. Therefore, when the air bag is deployed and inflated, a large force acts on the tether portion in a direction in which the tether portion is bridged over the seat support portion. Therefore, in order to further reduce the stretch and deformation of the tether portion, it is preferable to make the tether portion less susceptible to stretch and deformation in the direction in which the tether portion is bridged over the seat support portion. Hereinafter, as necessary, the direction in which the tether portion is bridged over the seat support portion may be referred to as a bridging direction.

The fabric, which is the material for the tether portion, is greatly stretched and deformed when it is a bias fabric, but is less susceptible to stretching and deformation when it is a warp fabric or a weft fabric, and is particularly less susceptible to stretching and deformation when it is a warp fabric.

Here, the term “warp fabric” refers to a fabric in which a direction in which warp yarns extend coincides with a direction in which the force acts most in the fabric, and more specifically, refers to a fabric in which the direction in which warp yarns extend in the tether portion coincides with the bridging direction of the tether portion.

Further, the term “weft fabric” refers to a fabric in which a direction in which warp yarns extend is perpendicular to a direction in which the force acts most in the fabric, and more specifically, refers to a fabric in which the direction in which warp yarns extend in the tether portion is perpendicular to the bridging direction of the tether portion.

Further, the term “bias fabric” refers to a fabric in which a direction in which warp yarns extend is at 45 degrees to a direction in which the force acts most in the fabric, and more specifically, refers to a fabric in which the direction in which warp yarns extend in the tether portion is at 45 degrees to the bridging direction of the tether portion.

Based on the above, in order to further reduce the stretch and deformation of the tether portion, an angle formed by the bridging direction of the tether portion and the direction in which the warp yarns extend in the tether portion is preferably 0 degrees or 90 degrees, and particularly preferably 0 degrees.

Here, the angle formed by the bridging direction of the tether portion and the direction in which the warp yarns extend in the tether portion may not be exactly 0 degrees or 90 degrees, and may include a range of about +10 degrees between these angles.

As described above, the tether portion of the seat cushion air bag structure according to the present invention is bridged over the seat support portion in at least a partial region of the tether portion in the front-rear direction of the seat and/or in at least a partial region of the tether portion in the width direction of the seat. In other words, the tether portion may be bridged over the seat support portion in the front-rear direction or in the width direction. The tether portion may be bridged over the seat support portion in both the front-rear direction and the width direction.

The seat support portion is a member of the seat that is disposed below at least a part of the cushion portion and supports the cushion portion and the occupant sitting on the cushion portion from below. Specific examples thereof include a seat pan, a seat bar, and a side frame of the seat.

The seat pan is a plate-shaped member, and is generally bridged to the seat portion in the front-rear direction and the width direction based on the shape thereof, and is bridged to the seat frame of the seat in the front-rear direction and the width direction, thereby supporting the seat portion of the seat from below, and thus supporting the seat portion and the occupant sitting on the seat portion from below.

The seat bar is a rod-shaped member, and is bridged to the seat portion of the seat, more specifically, the seat frame in the width direction, thereby supporting the seat portion of the seat from below, and thus supporting the seat portion and the occupant sitting on the seat portion from below. The seat bar is generally disposed rearward of the seat pan, but may be disposed forward of the seat pan.

The seat may have only one seat bar or may have a plurality of seat bars. When the seat includes two or more seat bars, of two seat bars, the one positioned at the rear is referred to as a first seat bar, and the one positioned at the front is referred to as a second seat bar.

In a case where the seat includes, for example, one seat pan and one seat bar, the seat pan and the seat bar can be selected as the seat support portion over which the tether portion is bridged. In this case, it can be said that the tether portion is bridged in the front-rear direction in a region in the front-rear direction spanning the seat pan and the seat bar.

When the seat includes the first seat bar and the second seat bar described above, as the seat support portion over which the tether portion is bridged, the seat pan and the first seat bar may be selected, the seat pan and the second seat bar may be selected, the first seat bar and the second seat bar may be selected, or the seat pan, the first seat bar, and the second seat bar may be selected.

For example, in a case where the tether portion is bridged over the seat pan and the first seat bar, it can be said that the tether portion is bridged in the front-rear direction in a front-rear region spanning the seat pan and the first seat bar.

For example, in a case where the tether portion is bridged over the seat pan and the second seat bar, it can be said that the tether portion is bridged in the front-rear direction in a front-rear region spanning the seat pan and the second seat bar.

For example, in a case where the tether portion is bridged over the first seat bar and the second seat bar, it can be said that the tether portion is bridged in the front-rear direction in a front-rear region spanning the first seat bar and the second seat bar.

Further, the seat frame in the seat may be selected as the seat support portion. For example, two side frames which are part of the seat frame and which form side portions of the seat portion may be selected as the seat support portion. Since the side frames are separated in the width direction, in this case, the tether portion is bridged between one side frame and the other side frame in the width direction. In other words, in this case, it can be said that the tether portion is bridged in the width direction in a widthwise region spanning one side frame and the other side frame.

The seat support portion to be selected as the seat support portion over which the tether portion is bridged may be appropriately determined depending on the position of each seat support portion with respect to the seat surface of the seat, the position of the air bag, the shape of the tether portion, the shape of the air bag, and the like.

In order to more stably and more efficiently support the air bag, which is deployed and inflated when an impact occurs, from below using the tether portion, it is preferable to apply tension to the tether portion when an impact occurs in a direction in which the tether portion is bridged. That is, it is preferable that the seat cushion air bag structure according to the present invention includes a tension applying element for applying tension to the tether portion in the bridging direction of the tether portion when an impact occurs.

For example, in a case where the tether portion is bridged in the front-rear direction, the tension applying element may apply tension in the front-rear direction to the tether portion when an impact occurs.

Further, for example, in a case where the tether portion is bridged in the width direction, the tension applying element may apply tension in the width direction to the tether portion when an impact occurs.

A structure and a tension generating mechanism of the tension applying element are not particularly limited as long as the tension can be applied to the tether portion when the impact occurs.

For example, the air bag may be used as the tension applying element.

Specifically, the air bag may be provided with a downward pressing portion that protrudes downward at the time of deployment and inflation, and the downward pressing portion may be used as the tension applying element.

In a case where the seat cushion air bag structure according to the present invention has such a tension applying element, when the air bag is deployed and inflated at the time of occurrence of an impact, the downward pressing portion, which is a part of the air bag, protrudes downward. Then, the air bag further presses downward the tether portion positioned below the air bag, and as a result, tension in the bridging direction is applied to the tether portion.

The position of the downward pressing portion in the air bag is not particularly limited. For example, the downward pressing portion is preferably disposed between the seat pan and the second seat bar or between the second seat bar and the first seat bar when the air bag is inflated.

Further, for example, when a part of the tether portion is positioned in front of and/or behind the air bag, the part may be used as the tension applying element.

That is, a part of the air bag moves upward in position at the time of deployment and inflation. The part of the tether portion positioned in front of and/or behind the air bag may be integrated with the part.

Hereinafter, the part of the air bag that moves upward in position at the time of deployment and inflation is referred to as an upward pulling portion as necessary.

In this case, when the air bag is deployed and inflated at the time of occurrence of an impact, the upward pulling portion, which is a part of the air bag, moves upward in position, and the part of the tether portion integrated with the upward pulling portion is pulled upward accordingly. As a result, tension is applied to the tether portion in the bridging direction.

Further, for example, the seat cushion air bag structure according to the present invention may include an electric actuator that is connected to the tether portion and configured to pull the tether portion when an impact occurs. In this case, the electric actuator may also be used as the tension applying element.

In this case, the electric actuator operates when an impact occurs, and the tether portion is pulled in response to the operation of the electric actuator. As a result, tension is applied to the tether portion in the bridging direction.

For example, when an electric motor is used as the electric actuator and a part of the tether portion is attached to a rotation shaft of the electric motor, the tether portion is wound up as the electric motor rotates. Accordingly, the above-described tension is applied to the tether portion.

Hereinafter, the seat cushion air bag structure according to the present invention will be described with reference to specific examples.

### First Embodiment

A seat cushion air bag structure according to a first embodiment includes a seat pan and two seat bars as the seat support portion, and an air bag has a downward pressing portion.

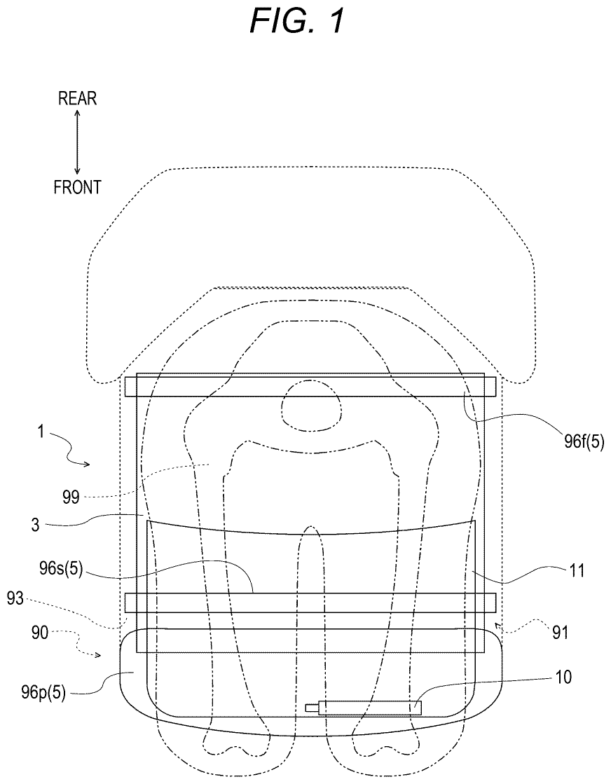

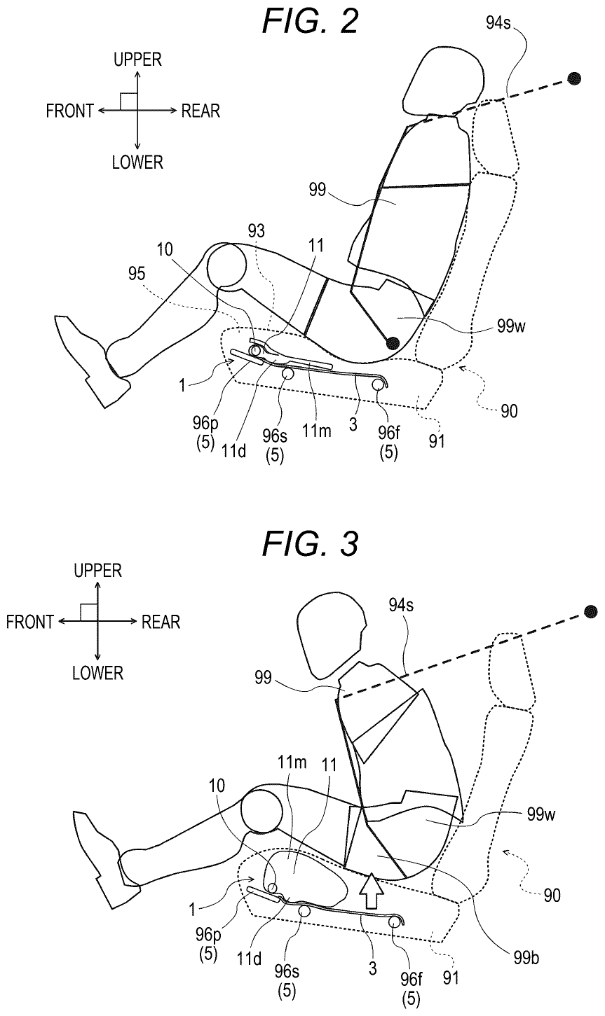

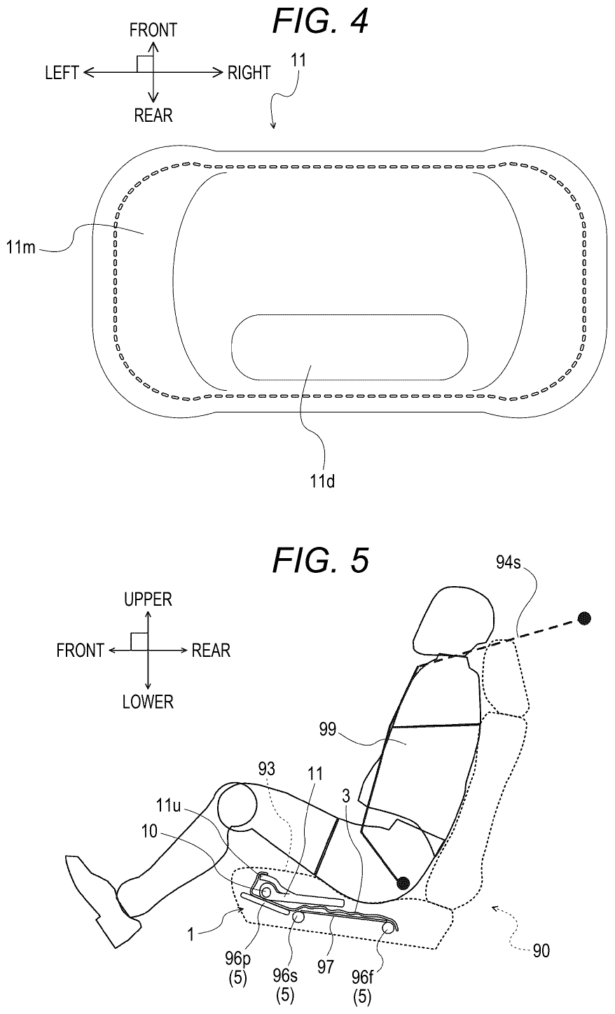

FIGS. 1 to 3 schematically illustrate the seat cushion air bag structure according to the first embodiment. FIG. 1 schematically illustrates the seat cushion air bag structure according to the first embodiment as viewed from above. FIG. 2 shows the seat cushion air bag structure according to the first embodiment when the air bag is in a normal state. FIG. 3 shows the seat cushion air bag structure according to the first embodiment when the air bag is deployed and inflated at the time of occurrence of an impact. FIG. 4 is a diagram schematically illustrating a state in which the air bag in the seat cushion air bag structure according to the first embodiment is viewed from below.

Hereinafter, in the first embodiment, upper, lower, left, right, front, and rear refer to upper, lower, left, right, front, and rear shown in the drawings. The left-right direction coincides with the width direction.

The seat cushion air bag structure according to the first embodiment includes a seat cushion air bag device 1 and a seat support portion 5.

As shown in FIG. 1, the seat cushion air bag device 1 includes an air bag 11 and an inflation fluid generation source 10.

The seat cushion air bag device 1 in the seat cushion air bag structure according to the first embodiment is mounted on a seat 90 for a vehicle, and more specifically, is disposed below a seat surface 93 in a seat portion 91 of the seat 90. It can be said that the seat cushion air bag device 1 in the seat cushion air bag structure according to the first embodiment is disposed below the seat surface 93 in the seat portion 91.

A seat pan 96p, a first seat bar 96f, and a second seat bar 96s are disposed inside the seat portion 91. The seat pan 96p is fixed to a seat frame (not shown) at a front end portion of the seat portion 91. The seat frame is a portion forming a lower portion of the seat portion 91 of the seat 90, is disposed below a cushion 95, and has a function of supporting the entire seat portion 91 including the cushion 95.

The seat frame (not shown) includes two side frames separated from each other in the width direction and a front frame positioned at the front and connecting the two side frames.

The seat pan 96p is bridged over the front frame and front portions of the two side frames of the seat frame.

The first seat bar 96f and the second seat bar 96s are bridged over the two side frames behind the seat pan 96p. The first seat bar 96f is behind the second seat bar 96s, and the second seat bar 96s is disposed between the seat pan 96p and the first seat bar 96f.

The air bag 11 is positioned inside the seat portion 91 and above the seat pan 96p and the second seat bar 96s. The air bag 11 is disposed in a front region, which is a region between a central portion and a front end portion of the seat portion 91 in the front-rear direction.

The inflation fluid generation source 10 is disposed inside the air bag 11 and further forward than the second seat bar 96s.

The inflation fluid generation source 10 in the seat cushion air bag device 1 is an inflator that generates gas as an inflation fluid, is connected to a control device (not shown) for deploying and inflating the air bag 11, and is operated by receiving a supply of electric power. The control device is an electronic control unit (ECU) of the vehicle.

The air bag 11 is made of polyester woven fabric. As shown in FIGS. 2 to 4, the air bag 11 includes a bag-shaped main body portion 11m and a bag-shaped downward pressing portion 11d integrated with a lower surface of the main body portion 11m. The downward pressing portion 11d has a protruding end facing downward. The inside of the downward pressing portion 11d communicates with the inside of the main body portion 11m.

Therefore, when the inflation fluid generated by the inflation fluid generation source 10 is supplied to the inside of the main body portion 11m during deployment and inflation of the air bag 11, the inflation fluid is also supplied to the inside of the downward pressing portion 11d communicating with the main body portion 11m. Therefore, at this time, the downward pressing portion 11d protrudes downward (FIG. 3).

In the seat cushion air bag device 1 according to the first embodiment, when the air bag 11 is inflated, the downward pressing portion 11d is disposed between the seat pan 96p and the second seat bar 96s, and presses a tether portion 3 downward between the seat pan 96p and the second seat bar 96s. Alternatively, the downward pressing portion 11d may be disposed between the second seat bar 96s and the first seat bar 96f when the air bag 11 is inflated. In this case, the downward pressing portion 11d presses the tether portion 3 downward between the seat pan 96p and the second seat bar 96s.

Note that, for reference, in the seat cushion air bag structure according to the first embodiment, a length of the downward pressing portion 11d in the front-rear direction is preferably about 25% to 50% of a length of the air bag 11 in the front-rear direction, in other words, a length of the main body portion 11m in the front-rear direction. A length of the downward pressing portion 11d in the width direction is preferably about 80% to 100% of a length of the air bag 11 in the width direction, in other words, a length of the main body portion 11m in the width direction.

In the seat cushion air bag structure according to the first embodiment, the length of the main body portion 11m in the front-rear direction is about 200 mm, and the length of the main body portion 11m in the width direction is about 400 mm. Further, the length of the downward pressing portion 11d in the front-rear direction is about 50 mm, and the length of the downward pressing portion 11d in the width direction is about 380 mm.

The tether portion 3 is made of the same polyester woven fabric as the air bag 11, and is bridged in the front-rear direction over the seat pan 96p, the second seat bar 96s, and the first seat bar 96f.

In the seat cushion air bag structure according to the first embodiment, a length of the tether portion 3 in the front-rear direction is about 75% of a length of the seat portion 91 in the front-rear direction, and a length of the tether portion 3 in the width direction is about 90% of a length of the seat portion 91 in the width direction.

A front end portion of the tether portion 3 is fixed to the seat pan 96p by a bolt (not shown). A rear end portion of the tether portion 3 is fixed to the first seat bar 96f by a hook (not shown). A central portion of the tether portion 3 in the front-rear direction spans over the second seat bar 96s which is between the seat pan 96p and the first seat bar 96f.

A direction in which warp yarns extend in the tether portion 3 substantially coincides with the front-rear direction. Therefore, an angle formed by a direction in which the tether portion 3 is bridged over the seat support portion 5 and the direction in which the warp yarns extend in the tether portion 3 is substantially 0 degrees.

In the seat cushion air bag structure according to the first embodiment, the tether portion 3 is provided below the air bag 11. Therefore, when the air bag 11 is deployed and inflated at the time of occurrence of an impact and the downward pressing portion 11d protrudes downward, the tether portion 3 below the air bag 11 is pressed downward by the downward pressing portion 11d of the air bag 11.

As shown in FIG. 1, the tether portion 3 has a band shape extending in the width direction and the front-rear direction, and is bridged in the front-rear direction. In other words, the tether portion 3 in the seat cushion air bag structure according to the first embodiment extends over a partial region in the front-rear direction and a partial region in the width direction with respect to the seat portion 91 of the seat 90, and is bridged over the seat support portion 5 particularly in the partial region in the front-rear direction.

Therefore, when the air bag 11 is deployed and inflated, the tether portion 3 comes into contact with the air bag 11 over a large area, and can efficiently receive an external force generated by the air bag 11.

When the air bag 11 is deployed and inflated, the tether portion 3 pressed downward by the downward pressing portion 11d is stretched in the front-rear direction. That is, in the seat cushion air bag structure according to the first embodiment, the downward pressing portion 11d applies tension in the front-rear direction to the tether portion 3 when an impact occurs (FIG. 3).

The tether portion 3 is bridged over the seat pan 96p, the second seat bar 96s, and the first seat bar 96f, which are the seat support portion 5 as described above. Therefore, when the tether portion 3 receives an external force generated by the air bag 11 during deployment and inflation, the tether portion 3 generates a reaction force caused by the external force, and stably supports the air bag 11 from below. Further, the downward pressing portion 11d applies tension in the front-rear direction to the tether portion 3, the tether portion 3 more stably and more efficiently supports the air bag 11 from below.

Thus, according to the seat cushion air bag structure of the first embodiment, when an impact occurs, the air bag 11 can be deployed and inflated to a high position, buttocks 99b of an occupant 99 can be sufficiently lifted from below, and therefore a waist 99w of the occupant 99 can be sufficiently lifted to stably restrain and support the occupant 99 by a seat belt 94s.

The tether portion 3 is bridged over the seat support portion 5 in a relatively large region in the front-rear direction and the width direction. Therefore, the tether portion 3 receives the external force generated by the air bag 11 at the time of deployment and inflation in a relatively large area in a distributed manner, and the external force can be prevented from acting unevenly on the tether portion 3 and a part of the seat 90. Thus, according to the seat cushion air bag structure of the first embodiment, it is possible to prevent defects such as deformation of a part of the seat 90 including the seat support portion 5.

The tether portion 3 is made of fabric and is bendable and deformable. Therefore, when the occupant 99 is seated on the seat 90 and the seat surface 93 of the seat 90 is deformed downward, the tether portion 3 below the seat surface 93 of the seat 90 follows the deformation and is bent and deformed downward. In other words, at this time, the tether portion 3 is bent and deformed downward along the buttocks 99b of the occupant 99. Therefore, the tether portion 3 is unlikely to impair the cushioning property of the seat 90, and the sitting comfort of the seat 90 is maintained at a good level.

According to the seat cushion air bag structure of the first embodiment, by the cooperation described above, the tether portion 3 is brought into contact with the air bag 11 from below with a large area to support the air bag 11 at the time of deployment and inflation, and therefore the occupant 99 can be stably restrained and supported by the seat belt 94s when an impact occurs. In addition, according to the seat cushion air bag structure of the first embodiment, the sitting comfort of the seat 90 is maintained at a good level.

### Second Embodiment

A seat cushion air bag structure according to a second embodiment is substantially the same as the seat cushion air bag structure according to the first embodiment except for the tension applying element.

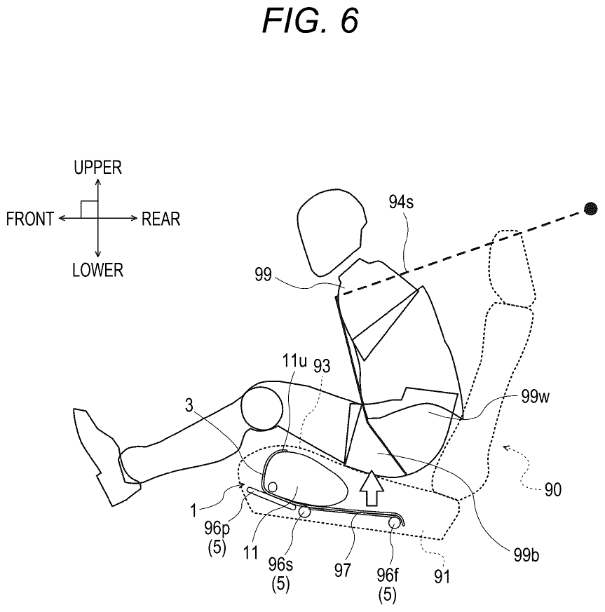

FIGS. 5 and 6 schematically illustrate the seat cushion air bag structure according to the second embodiment.

Hereinafter, the seat cushion air bag structure according to the second embodiment will be described focusing on differences from the first embodiment.

As shown in FIGS. 5 and 6, in the seat cushion air bag structure according to the second embodiment, the air bag 11 does not have the downward pressing portion 11d, and instead, a part of the tether portion 3 positioned in front of the air bag 11 is integrated with an upward pulling portion 11u positioned on the front side and the upper side of the air bag 11.

The upward pulling portion 11u of the air bag 11 is a portion that moves upward in position at the time of deployment and inflation, and the upward pulling portion 11u can be referred to as the tension applying element in the seat cushion air bag structure according to the first embodiment.

Since the part of the tether portion 3 positioned in front of the air bag 11 is integrated with the upward pulling portion 11u of the air bag 11, when the air bag 11 is deployed and inflated at the time of occurrence of an impact, the tether portion 3 is pulled forward and upward following the deployment and inflation. As a result, tension is applied to the tether portion 3 in the front-rear direction.

The seat cushion air bag structure according to the second embodiment includes the upward pulling portion 11u as the tension applying element instead of the downward pressing portion 11d. According to the seat cushion air bag structure of the second embodiment, similarly to the seat cushion air bag structure of the first embodiment, the tether portion 3 is brought into contact with the air bag 11 from below with a large area to support the air bag 11 at the time of deployment and inflation, and therefore the occupant 99 can be stably restrained and supported by the seat belt 94s when an impact occurs. In addition, according to the seat cushion air bag structure of the second embodiment, the sitting comfort of the seat 90 is also maintained at a good level.

Further, as shown in FIG. 5, in the seat cushion air bag structure according to the second embodiment, the tether portion 3 is disposed above a seat spring 97 and is interposed between the seat spring 97 and the air bag 11.

Therefore, as shown in FIG. 6, in the seat cushion air bag structure according to the second embodiment, the reaction force can be efficiently generated in the tether portion 3 while reducing the influence of the seat spring 97 during the deployment and inflation of the air bag 11, so that the air bag 11 can be efficiently supported from below by the tether portion 3, and the seat surface 93 of the seat 90 and the waist 99w of the occupant 99 sitting on the seat 90 can be quickly raised.

Therefore, according to the seat cushion air bag structure of the second embodiment, the occupant 99 can be more stably restrained and supported by the seat belt 94s when an impact occurs.

Although the present disclosure has been described above, the present invention is not limited to the above-described embodiments and the like, the elements described in the embodiments and the like can be appropriately extracted and combined, and various modifications can be made without departing from the scope of the present invention.

In addition, the description of the present invention is not limited to the citation relationships of claims at the beginning of the application, and discloses a technical idea obtained by appropriately combining the matters described in each claim.

### REFERENCE SIGNS LIST

1: seat cushion air bag device
11: air bag (seat cushion air bag)
11d: downward pressing portion (tension applying element)
11u: upward pulling portion (tension applying element)
3: tether portion
5: seat support portion
90: seat
93: seat surface
96p: seat pan
96f: first seat bar (seat bar)
96s: second seat bar (seat bar)

What is claimed is:

1. A seat cushion air bag structure comprising:
a seat support portion disposed below a seat surface of a seat of a vehicle;
a seat cushion air bag disposed below the seat surface and above the seat support portion and configured to be deployed and inflated when an impact occurs to the vehicle; and
a tether portion containing fabric,
wherein the tether portion is bridged over the seat support portion in at least one of: at least a partial region of the tether portion in a front-rear direction of the seat; or at least a partial region of the tether portion in a width direction of the seat, at a position below the seat cushion air bag.

2. A seat cushion air bag device comprising:
a seat cushion air bag disposed below a seat surface of a seat of a vehicle and above a seat support portion of the seat and configured to be deployed and inflated when an impact occurs to the vehicle; and
a tether portion containing fabric,
wherein the tether portion is bridged over the seat support portion in at least one of: at least a partial region of the tether portion in a front-rear direction of the seat; or at least a partial region of the tether portion in a width direction of the seat, at a position below the seat cushion air bag.

3. The seat cushion air bag device according to claim 2,
wherein the seat support portion includes
a seat bar bridged to a seat portion of the seat in the width direction, and
a seat pan having a plate shape and positioned in front of the seat bar in the front-rear direction, and
wherein the tether portion is bridged over the seat bar and the seat pan.

4. The seat cushion air bag device according to claim 2,
wherein the seat support portion includes at least two selected from:
a first seat bar bridged to a seat portion of the seat in the width direction;
a second seat bar bridged to the seat portion in the width direction and positioned in front of the first seat bar in the front-rear direction; and
a seat pan having a plate shape and positioned in front of the second seat bar, and
wherein the tether portion is bridged over the at least two selected from the first seat bar, the second seat bar, and the seat pan.

5. The seat cushion air bag device according to claim 2,
wherein the tether portion is bridged over the seat support portion in at least a partial region of the tether portion in the front-rear direction, and
wherein the seat cushion air bag device further comprises a tension applying element configured to, when the impact occurs, apply tension in the front-rear direction to the tether portion.

6. The seat cushion air bag device according to claim 3,
wherein the tether portion is bridged over the seat support portion in at least a partial region of the tether portion in the front-rear direction, and
wherein the seat cushion air bag device further comprises a tension applying element configured to, when the impact occurs, apply tension in the front-rear direction to the tether portion.

7. The seat cushion air bag device according to claim 5,
wherein the seat cushion air bag has a downward pressing portion configured to protrude downward when the seat cushion air bag is deployed and inflated, and
wherein the tension applying element is the downward pressing portion.

8. The seat cushion air bag device according to claim 6,
wherein the seat cushion air bag has a downward pressing portion configured to protrude downward when the seat cushion air bag is deployed and inflated, and
wherein the tension applying element is the downward pressing portion.

9. The seat cushion air bag device according to claim 5,
wherein the seat cushion air bag has an upward pulling portion configured to move upward in position when the seat cushion air bag is deployed and inflated,
wherein a part of the tether portion positioned at least one of: in front of; or behind the seat cushion air bag in the front-rear direction is integrated with the upward pulling portion, and
wherein the tension applying element is the upward pulling portion.

10. The seat cushion air bag device according to claim 6,
wherein the seat cushion air bag has an upward pulling portion configured to move upward in position when the seat cushion air bag is deployed and inflated,
wherein a part of the tether portion positioned at least one of: in front of; or behind the seat cushion air bag in the front-rear direction is integrated with the upward pulling portion, and
wherein the tension applying element is the upward pulling portion.

11. The seat cushion air bag device according to claim 5, further comprising:
an electric actuator connected to the tether portion and configured to pull the tether portion when the impact occurs,
wherein the tension applying element is the electric actuator.

12. The seat cushion air bag device according to claim 6, further comprising:
an electric actuator connected to the tether portion and configured to pull the tether portion when the impact occurs,
wherein the tension applying element is the electric actuator.

13. The seat cushion air bag device according to claim 2,
wherein an angle formed by a direction in which the tether portion is bridged over the seat support portion and a direction in which a warp yarn extends in the tether portion is 0 degrees or 90 degrees.

14. The seat cushion air bag device according to claim 3,
wherein an angle formed by a direction in which the tether portion is bridged over the seat support portion and a direction in which a warp yarn extends in the tether portion is 0 degrees or 90 degrees.
